(19) United States
(12) Patent Application Publication
(10) Pub. No.: US 2010/0330424 A1
(43) Pub. Date: Dec. 30, 2010

(54) NEGATIVE ELECTRODE FOR LITHIUM SECONDARY BATTERIES AND LITHIUM SECONDARY BATTERY

(75) Inventors: Kei Kobayashi, Kobe-shi (JP); Yasuo Takano, Nishinomiya-shi (JP); Taizou Sunano, Kobe-shi (JP); Maruo Kamino, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/822,696

(22) Filed: Jun. 24, 2010

(30) Foreign Application Priority Data
Jun. 24, 2009 (JP) 2009-149595

(51) Int. Cl. H01M 4/58; H01M 4/02

(52) U.S. Cl. 429/220; 429/231.95

(57) ABSTRACT

A negative electrode (2) for a lithium secondary battery having a negative electrode current collector (21) having an arithmetical mean surface roughness Ra of 0.01 μm or greater and a negative electrode active material layer (22) formed on the negative electrode current collector (21). The negative electrode active material layer (22) contains a negative electrode active material (22a) including a material capable of alloying with lithium. A conductive layer (23) including a material not intercalating or deintercalating lithium is formed on the negative electrode active material layer.

### BACKGROUND OF THE INVENTION

1. Field of the Invention

The present invention relates to a negative electrode for lithium secondary batteries, in which a negative electrode active material layer containing a material capable of alloying with lithium as a negative electrode active material is formed on a negative electrode current collector. The invention also relates to a lithium secondary battery using this negative electrode for lithium secondary batteries.

2. Description of Related Art

In recent years, lithium secondary batteries have been in use as power sources for mobile electronic devices and electric power storage. A lithium secondary battery typically uses a non-aqueous electrolyte and performs charge-discharge operations by transferring lithium ions between the positive electrode and the negative electrode.

In this type of lithium secondary battery, graphite materials have been widely used as a negative electrode active material in the negative electrode. The use of graphite materials has the following advantages. A flat discharge potential is obtained, and in addition, lithium ions are inserted and deinserted between graphite crystal layers during charge and discharge. Therefore, formation of lithium dendrite is inhibited, and the volumetric change of the material resulting from charge and discharge is kept small.

Meanwhile, significant size and weight reductions in mobile electronic devices such as mobile telephones, notebook computers, and PDAs have been achieved in recent years. On the other hand, power consumption of such devices has been increasing as the number of functions of the devices has increased. As a consequence, demand has been increasing for lighter weight and higher capacity lithium secondary batteries used as the power sources for such devices.

However, when a graphite material is used for the negative electrode active material, the capacity in the graphite material is not quite sufficient, and the above-mentioned demand cannot be sufficiently met. For this reason, the use of a material that can form an alloy with lithium, such as silicon, germanium, and tin, as a high capacity negative electrode active material has been investigated in recent years. In particular, silicon shows a high theoretical capacity of about 4000 mAh per 1 g, so the use of silicon and silicon alloys as the negative electrode material has been investigated.

The negative electrode active materials that can form an alloy with lithium, such as silicon, show large volumetric changes resulting from lithium intercalation and deintercalation. When a lithium secondary battery employing a negative electrode in which a layer of such a negative electrode active material is formed on a surface of a negative electrode current collector is charged and discharged, the negative electrode active material undergoes a volumetric change, causing stress within the negative electrode active material and between the negative electrode active material and the negative electrode current collector. This causes the negative electrode active material to pulverize or to peel off from the negative electrode current collector, degrading charge-discharge cycle performance and high rate charge-discharge characteristics.

Japanese Published Unexamined Patent Application No. 8-50922 discloses that a metal incapable of making an alloy with lithium is used as a current collector, that a negative electrode active material layer containing a metal element capable of making an alloy with lithium is provided on the current collector, and that a metal element incapable of making an alloy with lithium is disposed on a surface of the layer of the negative electrode active material. The publication states that, thereby, deterioration in the current collection performance in planar directions is inhibited in the negative electrode surface, in which pulverization tends to occur most, so that development of the pulverization is suppressed (see, for example, FIG. 2(b) and paragraph [0037] of the publication).

However, even when a layer of the negative electrode active material containing a metal element capable of making an alloy with lithium is provided on the current collector and a metal element incapable of making an alloy with lithium is disposed on a surface of the negative electrode active material, stress occurs between the negative electrode active material and the current collector because of a volumetric change of the negative electrode active material during charge and discharge of the lithium secondary battery. Consequently, the negative electrode active material peels off from the negative electrode current collector, and the negative electrode active material pulverizes inside the negative electrode active material layer. As a consequence, charge-discharge cycle performance and high rate charge-discharge characteristics cannot be improved sufficiently.

Japanese Published Unexamined Patent Application No. 2003-7305 discloses that a thin film of a negative electrode active material capable of forming an alloy with lithium is formed on a surface of a negative electrode current collector having a predetermined surface roughness Ra, and cuts corresponding to the surface irregularities of the negative electrode current collector are formed in the thin film of the negative electrode active material by charge and discharge, so that the thin film of the negative electrode active material are divided into columnar shapes. It is proposed that since gaps are formed around the portions divided into columnar shapes, the gaps absorb the expansion and shrinkage of the negative electrode active material resulting from charge and discharge, to prevent the negative electrode active material from peeling from the negative electrode current collector and from pulverizing (see, for example, paragraph [0016] of the publication).

However, when the thin film of the negative electrode active material formed on the negative electrode current collector surface having a predetermined surface roughness Ra is divided into columnar shapes as described above, the current collection performance within the negative electrode surface lowers, degrading high rate discharge characteristics.

### BRIEF SUMMARY OF THE INVENTION

It is an object of the present invention to inhibit the negative electrode active material in the negative electrode from pulverizing or peeling from a negative electrode current collector due to charge and discharge, in a lithium secondary battery employing a negative electrode having a negative electrode active material layer containing a material capable of alloying with lithium as a negative electrode active material formed on a negative electrode current collector, and to improve the current collection performance in the negative electrode active material layer. It is also an object of the invention to improve charge-discharge cycle performance, high rate charge-discharge characteristics, and the like, and to maintain a high charge-discharge capacity in the lithium secondary battery.

To accomplish the foregoing and other objects, the present invention provides a negative electrode for lithium secondary batteries, comprising: a negative electrode current collector having an arithmetical mean surface roughness Ra of 0.01 μm or greater; a negative electrode active material layer, formed on the negative electrode current collector, containing a negative electrode active material comprising a material capable of alloying with lithium; and a conductive layer, formed on the negative electrode active material layer, comprising a material not capable of intercalating or deintercalating lithium.

Here, examples of the material not intercalating or deintercalating lithium used for the conductive layer include copper, silver, gold, platinum, nickel, titanium, and alloys thereof. Preferable examples include copper, silver, gold, platinum, and alloys thereof, which are materials having ductility. Although the negative electrode active material layer is divided into columnar shapes, forming the conductive layer by a material having ductility can prevent the conductive layer from being disconnected together with the division of the active material layer.

When forming such a conductive layer on the negative electrode active material layer, various methods may be employed, including evaporation, sputtering, plating, CVD, and coating. Evaporation is particularly preferable. When the conductive layer is formed by evaporation, the conductive layer does not become too dense but becomes porous. As a result, the non-aqueous electrolyte solution in the lithium secondary battery can infiltrate through the conductive layer into the negative electrode active material layer appropriately, improving high rate charge-discharge characteristics and the like.

In addition, when the conductive layer is formed with a certain thickness, the current collection performance in the negative electrode current collector surface can be ensured. If the thickness of the conductive layer is too small, the conductive layer is split as the lithium secondary battery is charged and discharged, deteriorating the current collection performance in the surface of the negative electrode. On the other hand, if the thickness of the conductive layer is too large, the thickness of the negative electrode active material layer decreases relatively. As a consequence, the amount of the negative electrode active material reduces, and the battery capacity becomes insufficient. For this reason, it is preferable that the conductive layer has a thickness of from 3 μm to 20 μm, more preferably from 3 μm to 10 μm.

Examples of the material capable of alloying with lithium used for the negative electrode active material layer include silicon, germanium, tin, lead, zinc, magnesium, sodium, aluminum, potassium, and indium. It is particularly preferable to use silicon, which has a high theoretical capacity. It is preferable to use a material containing silicon in an amount of 50 atom % or greater as the negative electrode active material.

When forming the negative electrode active material layer on the surface of the negative electrode current collector, various methods may be used, including coating, evaporation, sputtering, and CVD. Among them, coating is particularly preferable. Coating refers to a method of forming the negative electrode active material layer by coating a slurry containing powder of the material capable of alloying with lithium, powder of a conductive material, and a binder onto the surface of the negative electrode current collector. The use of coating can prevent the negative electrode active material from peeling from the negative electrode active material and from pulverizing, because of the presence of gaps between the powder particles absorbs the expansion and shrinkage of the negative electrode active material.

When the surface of the negative electrode current collector on which the negative electrode active material layer is formed has an arithmetical mean surface roughness Ra of 0.01 μm or greater, adhesion of the interface between the negative electrode current collector and the negative electrode active material layer is improved. The stress associated with expansion and shrinkage of the negative electrode active material during charge and discharge concentrates in planar directions of the negative electrode active material layer, causing cracks across the thickness of the negative electrode active material layer. Consequently, the negative electrode active material layer, while being kept in intimate contact with the negative electrode current collector, is split in columnar shapes. The gaps formed in the negative electrode active material layer, having been split in columnar shapes in this way, serve to alleviate the stress due to the expansion and shrinking of the negative electrode active material during subsequent charge and discharge. As a result, the negative electrode active material layer is prevented from forming further cracks, and the negative electrode active material layer is inhibited from pulverizing.

To obtain the negative electrode current collector having an arithmetical mean surface roughness Ra of 0.01 μm or greater, the surface of the negative electrode current collector may be roughened by various methods including plating, vapor deposition, etching, and polishing. The plating and the vapor deposition are techniques of roughening a surface of the negative electrode current collector by forming a thin film layer having irregularities on the current collector surface. Examples of the plating include electroplating and electroless plating. Examples of the vapor deposition include sputtering, CVD, and evaporation.

The lithium secondary battery of the present invention uses one of the negative electrodes for lithium secondary batteries described above as its negative electrode.

In the negative electrode for lithium secondary batteries of the present invention, a negative electrode active material layer containing a material capable of alloying with lithium as a negative electrode active material is formed on a negative electrode current collector having an arithmetical mean surface roughness Ra of 0.01 μm or greater. As a result, when charging and discharging a lithium secondary battery employing such a negative electrode, the negative electrode active material layer is split in columnar shapes while being kept in intimate contact with the negative electrode current collector because of the expansion and shrinkage of the negative electrode active material resulting from charge and discharge. Thus, the stress due to the expansion and shrinking of the negative electrode active material during subsequent charge and discharge is alleviated, and the negative electrode active material layer is prevented from pulverizing and peeling from the negative electrode current collector.

In addition, in the negative electrode for lithium secondary batteries of the present invention, a conductive layer comprising a material not capable of intercalating or deintercalating lithium is formed on the negative electrode active material layer. Therefore, the current collection performance in the negative electrode surface is improved by the conductive layer.

As a result, the lithium secondary battery that uses the negative electrode for lithium secondary batteries achieves improved charge-discharge cycle performance and high rate charge-discharge characteristics, while maintaining a high charge-discharge capacity.

### BRIEF DESCRIPTION OF THE DRAWINGS

FIG. 1 is a schematic cross-sectional view illustrating a lithium secondary battery fabricated in the Examples and Comparative Examples of the present invention;

FIG. 2 is a schematic cross-sectional view illustrating how a conductive layer made of a material not intercalating or deintercalating lithium is formed on a negative electrode active material layer formed on a negative electrode current collector, with the use of an evaporator, in an example of the present invention;

FIG. 3 is a schematic view illustrating a negative electrode surface before charge and discharge, in an example of the present invention;

FIG. 4 is a schematic view illustrating the surface of the negative electrode having been charged, in an example of the present invention;

FIG. 5 is a schematic view illustrating a surface of a negative electrode having been discharged, in which the conductive layer is formed of a material having ductility, in an example of the present invention; and

FIG. 6 is a schematic view illustrating a surface of a negative electrode having been discharged, in which the conductive layer is formed of a material not having ductility, in an example of the present invention.

### DETAILED DESCRIPTION OF THE INVENTION

### Examples

Hereinbelow, examples of the negative electrode for lithium secondary batteries and the lithium secondary battery according to the present invention will be described in detail. It will be demonstrated that the examples of the lithium secondary battery using the negative electrode for lithium secondary batteries achieves improved charge-discharge cycle performance and high rate charge-discharge characteristics, while maintaining a high charge-discharge capacity, in comparison with comparative examples. It should be construed that the negative electrode for lithium secondary batteries and the lithium secondary battery according to the present invention are not limited to the following examples, but various changes and modifications are possible without departing from the scope of the invention.

### Example 1

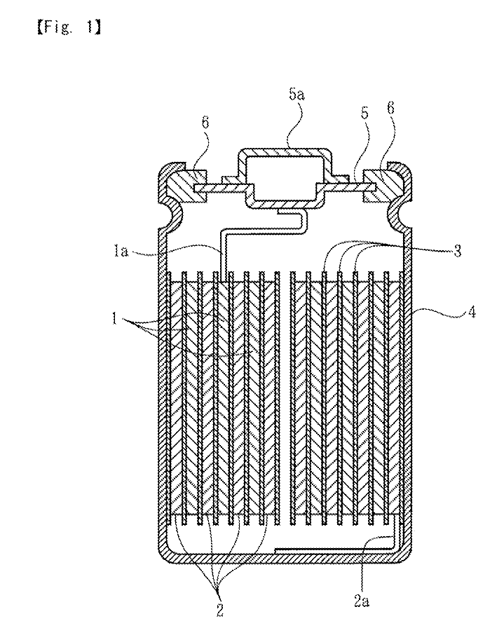

In Example 1, a cylindrical lithium secondary battery with a diameter of 12.8 mm and a height of 37.7 mm, as illustrated in FIG. 1, was fabricated using a positive electrode, a negative electrode, and a non-aqueous electrolyte solution that were prepared in the following manner.

### Preparation of Negative Electrode

A material capable of alloying with lithium, used as the negative electrode active material, was obtained in the following manner. A silicon seed placed in a reducing furnace was heated to 800° C. by passing electric current therethrough, and a mixed gas of high-purity monosilane (SiH₄) gas and hydrogen gas was flowed therein to deposit polycrystalline silicon on the surface of the silicon seed. Thereby, a polycrystalline silicon ingot was prepared. Then, the polycrystalline silicon ingot was pulverized and classified to prepare a negative electrode active material formed of polycrystalline silicon particles having a purity of 99%. The polycrystalline silicon particles had a crystallite size of 32 nm and an average particle size of 10 μm. The crystallite size was calculated by obtaining the half-width of the peak of the (111) plane of silicon by a powder X-ray diffraction analysis and using Scherrer's formula. The average particle size of the silicon particles was determined by a laser diffraction analysis.

Next, the above-described negative electrode active material, graphite powder having an average particle size of 3.5 μm as a conductive agent, and a varnish as a binder was mixed in N-methyl-2-pyrrolidone as a dispersion medium to obtain a negative electrode mixture slurry. The varnish was a precursor of a thermoplastic polyimide resin having the molecular structure represented by the following Chemical Formula 1, a glass transition temperature of about 300° C., and a weight-average molecular weight of about 50,000. The mass ratio of the negative electrode active material, the graphite powder as the conductive agent, and the thermoplastic polyimide resin as the binder was set at 100:3:8.6.

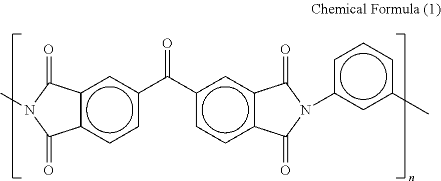

A 18 μm-thick copper alloy foil (C7025 alloy foil, composition: Cu 96.2 wt %, Ni 3 wt %, Si 0.65 wt %, Mg 0.15 wt %) was used for the negative electrode current collector. Both sides of the copper alloy foil were roughened by electrolytic copper plating. The roughened copper alloy foil has a surface roughness Ra of 0.25 μm and a mean spacing of local peaks S of 0.85 μm.

The negative electrode mixture slurry was applied to both sides of the just-described negative electrode current collector in the air at 25° C., and this was dried in the air at 120° C. and thereafter calendered in the air at 25° C. Thereafter, the resultant article was heat-treated in an argon atmosphere at 400° C. for 10 hours. Thus, a negative electrode active material layer was formed on each side of the negative electrode current collector.

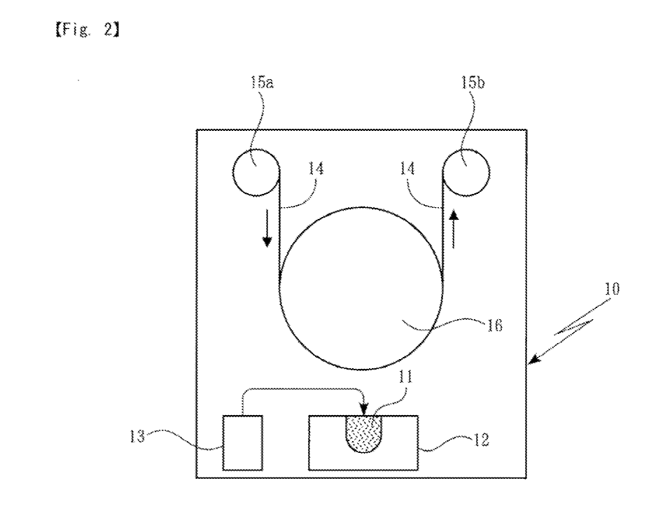

Next, a conductive layer made of Cu, the material not intercalating or deintercalating lithium, was formed on the negative electrode active material layer formed on each side of the negative electrode current collector, using an evaporator 10 shown in FIG. 2. Here, as illustrated in FIG. 2, the evaporator 10 is furnished with a crucible 12 for melting Cu, which is an evaporation source material 11, an electron beam gun 13, a pair of rollers 15a and 15b for winding a negative electrode current collector 14 on which the negative electrode active material layer is formed, and a supporting roller 16 for guiding the negative electrode current collector 14 between the rollers 15a and 15b.

The negative electrode current collector 14 was wound on one roller 15a. Then, the negative electrode current collector 14 was guided from the roller 15a to the other roller 15b by the supporting roller 16. Electric power was applied to the electron beam gun 15 to apply an electron beam from the electron beam gun 15 to the evaporation source material 11, Cu, accommodated in the crucible 14. Thereby, the evaporation source material 11, Cu, was melted evaporated so that the evaporation source material 11, Cu, was deposited on the negative electrode active material layer formed on the surface of the negative electrode current collector 14, guided by the supporting roller 17 from the roller 15a. Then, the negative electrode current collector 14 was wound on the roller 15b. Thereafter, the negative electrode current collector 14 was taken out from the evaporator 10, and the negative electrode current collector 14 wound on the roller 15b was turned inside out by a roll reversing apparatus (not shown).

Next, the negative electrode current collector 14 turned inside out was set in the evaporator 10, and the evaporation source material 11, Cu, was deposited on the negative electrode active material layer of the negative electrode current collector 14 on which the evaporation source material 11, Cu, had not yet been deposited, in the same manner as described above. Thus, the conductive layer made of Cu was formed on the negative electrode active material layer formed on each side of the negative electrode current collector 14.

In Example 1, the thickness of the conductive layer made of Cu was set at 3 μm by controlling the speed of the negative electrode current collector 14 guided by the supporting roller 17. The thicknesses of the conductive layers on both sides of the negative electrode current collector 14 were the same.

Then, the resultant article, in which the conductive layer was formed on the negative electrode active material layer formed on each side of the negative electrode current collector, was cut out in a sheet-like shape, and a negative electrode current collector tab was attached thereto, whereby a negative electrode was completed.

### Preparation of Positive Electrode

Li₂CO₃ and CoCO₃ were mixed in a mortar so that the mole ratio of Li and Co became 1:1. The mixture was sintered in an air atmosphere at 800° C. for 24 hours and thereafter pulverized to obtain powder of lithium cobalt oxide represented as LiCoO₂ and having an average particle size of about 11 μm. The lithium cobalt oxide powder thus obtained was used as a positive electrode active material. The lithium cobalt oxide powder had a BET specific surface area of 0.37 m²/g.

This positive electrode active material, carbon material powder having an average particle size of 2 μm as a conductive agent, and polyvinylidene fluoride as a binder were added to N-methyl-2-pyrrolidone as a dispersion medium so that the mass ratio thereof became 95:2.5:2.5, and the mixture was kneaded to prepare a positive electrode mixture slurry.

Next, the resultant positive electrode mixture slurry was applied onto both sides of a positive electrode current collector made of an aluminum foil having a thickness of 15 μm, and then dried. The resultant article was calendered and thereafter cut out into a sheet-like shape, and a positive electrode current collector tab made of aluminum was attached thereto. Thus, a positive electrode was prepared.

### Preparation of Non-Aqueous Electrolyte Solution

To prepare a non-aqueous electrolyte solution, a mixed solvent of 2:8 volume ratio of 4-fluoroethylene carbonate (FEC) and ethyl methyl carbonate (EMC) was prepared as a non-aqueous solvent, and lithium hexafluorophosphate LiPF₆ as a solute was dissolved in the mixed solvent at a concentration of 1.0 mol/L. Then, 0.4 wt % carbon dioxide gas was added thereto, to prepare a non-aqueous electrolyte solution.

### Preparation of Battery

To prepare a battery, as illustrated in FIG. 1, a lithium-ion-permeable polyethylene microporous film was interposed as a separator 3 between a positive electrode 1 and a negative electrode 2 that were prepared in the above-described manner, as illustrated in FIG. 1, and these were spirally coiled and placed in a battery can 4. Then, the positive electrode current collector tab 1a provided on the positive electrode 1 was connected to a positive electrode cap 5 on which a positive electrode external terminal 5a was provided, and the negative electrode current collector tab 2a provided on the negative electrode 2 was connected to the battery can 4. Thereafter, the battery can 4 was filled with the above-described non-aqueous electrolyte solution and then sealed. The battery can 4 and the positive electrode cap 5 were electrically isolated by an insulative packing 6. A lithium secondary battery was thus prepared.

### Examples 2 to 6

In Examples 2 to 6, negative electrodes were prepared by varying the thickness of the conductive layer in preparing the negative electrodes in the same manner as described in Example 1. The thickness of the conductive layer, made of Cu and formed on the negative electrode active material layer, was set at 10 μm in Example 2, 20 μm in Example 3, 30 μm in Example 4, 35 μm in Example 5, and 40 μm in Example 6. Lithium secondary batteries of Examples 2 to 6 were fabricated in the same manner as described in Example 1, except for using the respective negative electrodes prepared in the just-described manner.

### Comparative Example 1

In Comparative Example 1, the conductive layer made of Cu was not formed on the negative electrode active material layer formed on each side of the negative electrode current collector 14 when preparing the negative electrode in the manner described in Example 1. A lithium secondary battery of Comparative Example 1 was fabricated in the same manner as described in Example 1, except for using the negative electrode prepared in the just-described manner.

### Comparative Example 2

In Comparative Example 2, when preparing the negative electrode in the manner described in Example 1, the 18 μm-thick copper alloy foil (C7025 alloy foil, composition: Cu 96.2 wt %, Ni 3 wt %, Si 0.65 wt %, Mg 0.15 wt %) was not roughened by the electrolytic copper plating, and the copper alloy foil not roughened was used as the negative electrode current collector. The negative electrode current collector had a surface roughness Ra of 0.008 μm.

A lithium secondary battery of Comparative Example 2 was fabricated in the same manner as described in Example 1, except for using the negative electrode prepared in the just-described manner.

### Comparative Example 3

In Comparative Example 3, when preparing the negative electrode in the manner described in Example 1, a 3 μm-thick conductive layer made of graphite was formed on the negative electrode active material layer formed on each side of the negative electrode current collector by coating, in place of the conductive layer made of Cu. The conductive layer made of graphite was formed by coating in the following manner. Graphite powder as the material for the conductive layer and polyvinylidene fluoride as a binder were added at a mass ratio of 95:5 to N-methyl-2-pyrrolidone as a dispersion medium, and the mixture was kneaded to obtain a slurry. The resultant slurry was coated on the negative electrode active material layer, and then dried and calendered.

A lithium secondary battery of Comparative Example 3 was fabricated in the same manner as described in Example 1, except for using the negative electrode prepared in the just-described manner.

Next, each of the lithium secondary batteries of Examples 1 to 6 and Comparative Examples 1 to 3 was subjected to initial charging. Each of the batteries was charged at a constant current of 45 mA for 4 hours, thereafter charged at a constant current of 180 mA until the battery voltage reached 4.2 V, and further charged at a constant voltage of 4.2 V until the current value reached 45 mA. Then, each of the lithium secondary batteries having been subjected to the initial charging was subjected to an initial discharge, in which each battery was discharged at a constant current of 180 mA until the battery voltage reached 2.75 V, to obtain the initial discharge capacity of each of the lithium secondary batteries. Then, the initial discharge capacity of the lithium secondary battery of Comparative Example 1 was defined as an initial capacity characteristic of 100, and the initial capacity characteristic of each of the lithium secondary batteries was accordingly calculated. The results are shown in Table 1 below.

In addition, each of the lithium secondary batteries having been subjected to the initial discharging was charged at a constant current of 900 mA until the battery voltage reached 2.75 V and further charged at a constant voltage of 4.2 V until the current value reached 45 mA. Subsequently, each of the lithium secondary batteries charged in this way was constant-current-discharged at a high current of 2700 mA until the battery voltage reached 2.75 V, to obtain the high rate discharge capacity of each of the lithium secondary batteries. Then, the high rate discharge capacity with respect to the initial discharge capacity was determined as the high rate discharge ratio. The high rate discharge ratio of the lithium secondary battery of Comparative Example 1 was defined as a high rate characteristic of 100, and the high rate characteristic of each of the lithium secondary batteries was accordingly calculated. The results are also shown in Table 1 below.

In addition, each of the lithium secondary batteries discharged in the just-described manner was charged at a constant current of 900 mA until the battery voltage reached 4.2 V, then further charged at a constant voltage of 4.2 V until the current value reached 45 mA, and then discharged at a constant current of 900 mA until the battery voltage reached 2.75 V. This charge-discharge cycle was repeated 50 times. Then, the discharge capacity of each of the lithium secondary batteries at the 50th cycle was obtained, and the discharge capacity at the 50th cycle with respect to the initial discharge capacity was determined as the discharge capacity retention ratio at the 50th cycle. Then, the discharge capacity retention ratio of the lithium secondary battery of Comparative Example 1 at the 50th cycle was defined as a cycle characteristic of 100, and the cycle characteristic of each of the lithium secondary batteries was accordingly calculated. The results are also shown in Table 1 below.

TABLE 1

| | Surface | Conductive layer | | Initial | | |
|---|---|---|---|---|---|---|
| | rough- | | Thick- | capacity | High rate | Cycle |
| | ness | Mater- | ness | character- | character- | character- |
| | Ra (μm) | ial | (μm) | istic | istic | istic |
| Ex. 1 | 0.25 | Cu | 3 | 98 | 107 | 108 |
| Ex. 2 | 0.25 | Cu | 10 | 92 | 124 | 116 |
| Ex. 3 | 0.25 | Cu | 20 | 88 | 135 | 116 |
| Ex. 4 | 0.25 | Cu | 30 | 85 | 135 | 116 |
| Ex. 5 | 0.25 | Cu | 35 | 78 | 135 | 116 |
| Ex. 6 | 0.25 | Cu | 40 | 72 | 135 | 116 |
| Comp. | 0.25 | — | — | 100 | 100 | 100 |
| Ex. 1 | | | | | | |
| Comp. | 0.008 | Cu | 3 | 98 | 70 | 105 |
| Ex. 2 | | | | | | |
| Comp. | 0.25 | Graph- | 3 | 95 | 99 | 76 |
| Ex. 3 | | ite | | | | |

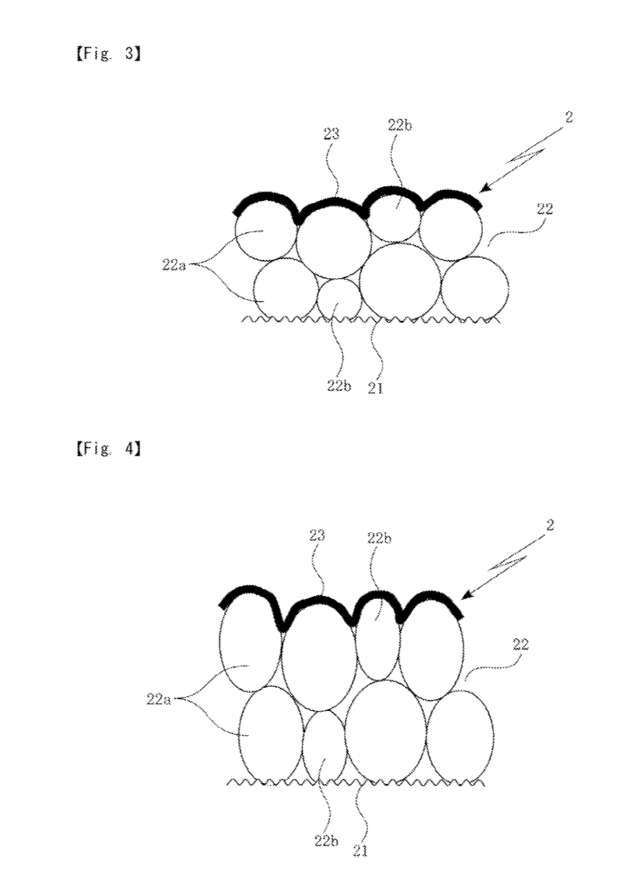

The lithium secondary batteries of Examples 1 to 5 exhibited improvements in high rate characteristic and cycle characteristic over the lithium secondary batteries of Comparative Examples 1 to 3. With reference to FIGS. 3 to 6, the following describes the changes of the negative electrode 2 in which the conductive layer 23 is provided on the surface of the negative electrode active material layer 22 formed on the roughened negative electrode current collector 21 that are observed when the negative electrode 2 is charged and discharged.

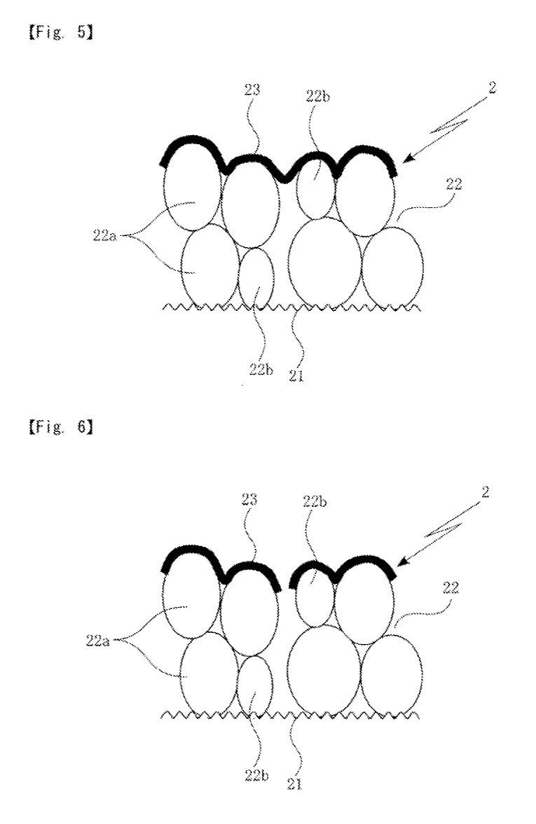

FIG. 3 shows a schematic view illustrating the negative electrode surface before subjected to charge and discharge. FIG. 4 shows a schematic view illustrating the negative electrode surface having been charged. FIG. 5 shows a schematic view illustrating a surface of a negative electrode having been discharged, in which the conductive layer is formed of a material having ductility. FIG. 6 shows a schematic view illustrating a surface of a negative electrode having been discharged, in which the conductive layer is formed of a material not having ductility.

When the negative electrode 2 is charged from the state in which the negative electrode is not yet charged and discharged as shown in FIG. 3, the negative electrode active material 22a in the negative electrode active material layer 22 expands as illustrated in FIG. 4. Subsequently, when the negative electrode 2 is discharged, the negative electrode active material 22a having expanded on the roughened negative electrode current collector 21 shrinks, and the negative electrode active material layer 22 is divided in columnar shapes. In this case, if the conductive layer 23 is made of a material having ductility, as illustrated in FIG. 5, the conductive layer 23 will expand so that the portion of the conductive layer 23 that is on the negative electrode active material layer 22 is kept in a continuous state even when the negative electrode active material layer 22 is divided in columnar shapes. As a result, the conductivity in the surface of the negative electrode 2 is maintained. On the other hand, if the conductive layer 23 is made of a material not having ductility, the conductive layer 23 will be likewise split as the negative electrode active material layer 22 is divided in columnar shapes, as illustrated in FIG. 6, so the conductivity in the surface of the negative electrode 2 reduces.

In the lithium secondary batteries of Examples 1 to 5, in which the conductive layer was formed of Cu, a material having ductility, the conductivity in the surface of the negative electrode was maintained in the above-described way. This is believed to be the reason why the lithium secondary batteries of Examples 1 to 5 exhibited improved high rate characteristics and cycle characteristics.

In contrast, in the lithium secondary battery of Comparative Example 1, no conductive layer was formed on the negative electrode active material layer. Therefore, it is believed that cracks developed in the negative electrode active material layer by the expansion and shrinkage of the negative electrode active material resulting from charge and discharge, and as a consequence, the current collection performance in the negative electrode surface degraded. It is also believed that when charge and discharge operations were repeated, the negative electrode active material layer was pulverized and the negative electrode active material was peeled from the negative electrode current collector.

The binder agent 22b likewise deforms as the negative electrode active material 22a expands and shrinks so as to form a part of the negative electrode active material layer 22 divided in columnar shapes.

The lithium secondary battery of Comparative Example 2 used the negative electrode current collector the surface of which was not roughened was used. Therefore, in the lithium secondary battery of Comparative Example 2, adhesion between the negative electrode active material layer and the negative electrode current collector was poor, so the current collection performance in the interface between the negative electrode active material layer and the negative electrode current collector and that in the negative electrode active material layer degraded due to the expansion and shrinkage of the negative electrode active material resulting form charge and discharge. This is believed to be the reason why the high rate characteristic and the cycle characteristic were poorer than those of the lithium secondary batteries of Examples 1 to 5.

In the lithium secondary battery of Comparative Example 3, the conductive layer was formed by coating. Therefore, the non-aqueous electrolyte solution was less easily permeated into the negative electrode active material layer through the conductive layer. Moreover, because the conductive layer was formed of graphite, a material not having ductility, cracks gradually developed in the conductive layer due to charge and discharge. This is believed to be the reason why the high rate characteristic and the cycle characteristic were poorer than those of the lithium secondary batteries of Examples 1 to 5.

In comparing the lithium secondary batteries of Examples 1 to 5 with each other, as the thickness of the conductive layer made of Cu is thicker, the thickness of the negative electrode active material layer relatively decreases, which means that the amount of the negative electrode active material becomes less and the initial capacity characteristic becomes poorer. For this reason, it is preferable that the thickness of the conductive layer made of Cu be within the range of from 3 μm to 40 μm.

In addition, in order to obtain a sufficiently improved high rate characteristic, it is necessary that the conductive layer be thick to a certain degree. However, the batteries of Examples 3 to 5 showed saturated high rate characteristics. For this reason, it is preferable that the thickness of the conductive layer be within the range of from 3 μm to 20 μm.

Moreover, in order to obtain a good cycle characteristic, it is necessary that the conductive layer be formed thick to a certain degree. However, the batteries of Examples 2 to 5 showed saturated cycle characteristics. For this reason, it is more preferable that the thickness of the conductive layer be within the range of from 3 μm to 10 μm.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A negative electrode for a lithium secondary battery, comprising:
a negative electrode current collector having an arithmetical mean surface roughness Ra of 0.01 μm or greater;
a negative electrode active material layer, formed on the negative electrode current collector, containing a negative electrode active material comprising a material capable of alloying with lithium; and
a conductive layer, formed on the negative electrode active material layer, comprising a material not capable of intercalating or deintercalating lithium.

2. The negative electrode for a lithium secondary battery according to claim 1, wherein the conductive layer is formed of a material that has ductility.

3. The negative electrode for a lithium secondary battery according to claim 2, wherein the material forming the conductive layer comprises copper and/or a copper alloy.

4. The negative electrode for a lithium secondary battery according to claim 1, wherein the conductive layer is formed by evaporation.

5. The negative electrode for lithium a secondary battery according to claim 1, wherein the conductive layer has a thickness of from 3 μm to 20 μm.

6. The negative electrode for lithium a secondary battery according to claim 5, wherein the conductive layer has a thickness of from 3 μm to 10 μm.

7. The negative electrode for a lithium secondary battery according to claim 1, wherein the material capable of alloying with lithium in the negative electrode active material layer contains silicon as its main component.

8. The negative electrode for a lithium secondary battery according to claim 1, wherein the negative electrode active material layer is divided into columnar shapes and the conductive layer formed on the negative electrode active material layer is capable of expanding and contracting to maintain conductivity of a surface of the negative electrode active material layer during expansion and shrinkage of the negative electrode active material resulting from charge and discharge.

9. A lithium secondary battery comprising: a positive electrode; a non-aqueous electrolyte; and a negative electrode according to claim 1.
